(19) United States
(12) Patent Application Publication
(10) Pub. No.: US 2014/0037837 A1
(43) Pub. Date: Feb. 6, 2014

(54) BIO-RENEWABLE VINYL BEADS

(71) Applicants: Gerardus Cornelis Overbeek, Waalwijk (NL); Tijs Nabuurs, Waalwijk (NL); Adrianus Antonius johannes Van Geel, Waalwijk (NL)

(72) Inventors: Gerardus Cornelis Overbeek, Waalwijk (NL); Tijs Nabuurs, Waalwijk (NL); Adrianus Antonius johannes Van Geel, Waalwijk (NL)

(73) Assignee: DSM IP ASSETS B.V., Heerlen (NL)

(21) Appl. No.: 13/995,695

(22) PCT Filed: Dec. 20, 2011
(86) PCT No.: PCT/EP2011/073443

§ 371 Date: Oct. 23, 2013

(30) Foreign Application Priority Data
Dec. 20, 2010 (EP) 10195940.1

(51) Int. Cl. C08F 22/10

(52) U.S. Cl. CPC C08F 22/10
USPC 427/136; 526/224; 524/559; 427/385.5; 427/388.4; 427/391; 427/393

(57) ABSTRACT

A process for preparing vinyl polymer beads said process comprising aqueous suspension polymerisation of olefinically unsaturated monomers using a free-radical initiator, wherein at least 20 wt % of the olefinically unsaturated monomers used is derived from at least one bio-renewable olefinically unsaturated monomer.

The present invention relates to vinyl polymer beads comprising at least 10% by weight (preferably at least 20 wt %) bio-renewable monomers and to such vinyl polymer beads as well as a process for making them and their use in coatings, inks and adhesives.

Furthermore there is an increasing demand to use bio-renewable monomers in order to improve the sustainability of the polymers used in for example coating applications. In view of concerns about depletion of fossil fuel resources or an increase in carbon dioxide in the air that poses a global-scale environmental problem in recent years, methods for producing raw materials of these polymers from biomass resources have attracted al lot of attention. Since these resources are renewable and therefore have a carbon-neutral biomass, such methods in particular are expected to gain importance in the future.

Vinyl polymers which are prepared with emulsion polymerisation technology allow a good control over critical polymer parameters like molecular weight, particle size in the nm (nanometre) range (typically 50-300 nm) and residual monomer content. However, no micron-sized particles are obtained during emulsion polymerisation. Due to the small particle size dried emulsion vinyl polymers have a much larger dusting tendency compared to dried vinyl polymer beads obtainable by suspension polymerization. On the other hand polymer emulsions used as such to avoid the dusting issue need to be preserved to prevent bacterial or fungal growth.

The problem of dustiness of dried emulsion polymers can be overcome by bead-type suspension polymerisation which is a well known method of polymerisation in which the polymer formed is obtained as micron sized spherical beads or pearls. However, even though the water soluble by-products may be removed with the stationary water phase during the final de-watering and washing cycle the water insoluble by-products such as in particular the unreacted monomers stay within the polymer beads and lead to characteristic off odours, lowered glass transition temperatures (T_{g}) and toxicological issues, especially when the monomers are taken from vinyl acid/methyl vinyl acid and their esters.

By the term “polymer beads” in connection with the present invention is meant polymer particles that are simple to isolate e.g. by filtering or centrifuging. The polymer beads in connection with the present invention are micron-sized, for example. typically have an average diameter of at least 50 μm (micron), preferably at least 150 μm (micron). Generally, the beads have an average diameter between 50 and 1500 μm (micron) and more preferably between 150 to 600 μm (micron).

As used herein the term ‘micron sized’ denotes an object that has at least one linear dimension having a mean size between about 0.1 μm (1 μm=one micron=1×10⁻⁶ m) to about 2000 μm. A preferred mean size for the micron-sized materials described herein is less than about 1500 μm (micron), more preferably less than about 1000 μm (micron) most preferably less than about 600 μm (micron). Micron-sized materials exist with the micron-size in three dimensions (micro-particles), two dimensions (micro-tubes having a micro-sized cross section, but indeterminate length) or one dimension (micro-layers having a micro-sized thickness, but indeterminate area). Usefully the present invention relates to materials that comprise micro-particles. The particle size values given herein may be measured by a Coulter LS230 Particle Size Analyser (laser diffraction) and are the volume mean. The particle sizes are quoted as a linear dimension which would be the diameter of an approximate spherical particle having the same volume as the volume mean measured.

Such vinyl polymer beads are widely applied in the field of coatings (e.g. road markings, marine coatings), adhesives, colorants, photographic applications, inks, powder coatings or plastics filler and even in personal care products if the residual monomer content is low enough. The beads may be used in a liquid medium which may be aqueous or solvent based. Preferably if a solvent is used, a bio-renewable solvent is used. Bio-renewable solvents include for example bio-alcohols, xylene, butyl acetate, ethyl acetate, ethyl lactate and the VertecBio™ solvents available from Liberty Chemicals.

The preparation of vinyl polymer beads is well know and is described in for example EP739359 which discloses the use of a cobalt chelate for Mw control and in U.S. Pat. No. 4,463,032 which discloses polymers in bead form which are conventionally produced by a bead (suspension) polymerisation method where with this method, the monomers (disperse phase) are dispersed in a non-solvent (continuous phase) by mechanical action (agitation) and polymerised in that form.

Thus, the invention relates to a process for preparing vinyl polymer beads having a molecular weight in the range of from 3,000 to 500,000 g/mol and a glass transition temperature in the range of from 30° C. to 175° C. and an acid value in the range of from 0 to 150 mgKOH/g; said process comprising aqueous suspension polymerisation of olefinically unsaturated monomers using a free-radical initiator, wherein at least 20 wt % of the olefinically unsaturated monomers used is derived from at least one bio-renewable olefinically unsaturated monomer.

The dispersed phase/continuous phase ratio is typically from 10/90 to 50/50 wt % and more preferably from 30/70 to 45/55 wt %.

In another embodiment, the invention relates to vinyl polymer beads obtainable by the process according to the invention. In particular the vinyl polymer beads according to the invention have a residual monomer content of less than 2500 ppm and more preferably less than 1000 ppm.

The vinyl polymer beads according to the invention are prepared by suspension polymerisation (also known as granular, bead, or pearl polymerisation due to the shape of the resultant polymer particles) according to known methods in the art as illustrated in the examples.

Initiators for polymerizing the monomers to provide the vinyl polymer beads of the invention are those which are normally suitable for free-radical polymerisation of acrylate monomers and which are oil-soluble and have low solubility in water such as e.g. organic peroxides, organic peroxyesters and organic azo initiators. The initiator is generally used in an amount of about 0.1 to 2 wt % based on the total monomer content.

Useful chain transfer agents include mercapto-acids and alkyl esters thereof, carbon tetrabromide, mixtures thereof and cobalt chelate. Dodecylmercaptane is preferred. The mercapto chain transfer agent generally is used in an amount of about 0.01 to 3.0 wt %, preferably in an amount of 0.1 to 2 wt % based on the total monomer content. Typical cobalt chelate levels used range from 1 to 200 ppm and more preferably from 10 to 100 ppm.

Optionally, a water soluble inhibitor can be added to inhibit polymerisation in the water phase in order to prevent the formation of too much polymer by emulsion and/or solution polymerisation in the water phase, which can result in bead agglomeration or emulsion type polymerization. Suitable inhibitors include those selected from thiosulfates, thiocyanates, water soluble hydroquinones and nitrites. When used, the water soluble inhibitor can generally be added in an amount of from about 0.01 to about 1 parts by weight based on 100 parts total monomer content.

Furthermore, a water soluble or water dispersible polymeric stabiliser is needed to stabilize the suspension and in order to obtain stable beads. The stabiliser is preferably a synthetic water soluble or water dispersible polymer such as e.g. polyvinylalcohol, gelatine, starch, methylcellulose, carboxymethylcellulose, polyacrylic acid, polymethacrylic acid, hydroxyethylcellulose, poly(meth)vinyl acid and their ammonium, lithium, sodium, or potassium salts, and the like. The stabiliser is preferably used in an amount of about 0.001 to 10 wt %, more preferable in an amount of about 0.01 to 1 wt % based on the total monomer content.

Other additives can optionally be used such as e.g. mono-, di- and trivalent metal salts, borax, urea, glyoxal and urea formaldehyde resin. Biocides (both bactericides and fungicides) can also be added, in order to prevent microbial growth in the finished product and during its use in waterbased systems.

The monomers, free-radical initiator, and any optional materials can be mixed together in the prescribed ratio to form a premix. The stabiliser can be combined with water and then with the premix to form an oil in water suspension. The resulting suspension typically comprises from about 10 to about 50 weight percent monomer premix and from about 90 to about 50 weight percent water phase. Bead-type suspension polymerisation in accordance with the present invention is typically a thermally initiated polymerisation and is preferably carried out with agitation for about 2 to about 16 hours at a temperature between about 40° C. and 90° C.

After isolation of the beads according to standard methods such as filtration or centrifugation the beads are preferably subjected to an extended drying, preferably at about 40 to 100° C. depending on the actual Tg of the final polymer composition. The drying can be performed by commonly known means to a person skilled in the art such as e.g. using a fluidised bed dryer or a conventional oven. The drying time can be easily adjusted by a person skilled in the art and is usually carried out over a period of 3 to 40 h such as about 8 to 20 h and in particular about 8 to 10 h.

In a preferred embodiment the process further comprises the isolation of the vinyl polymer beads followed by a drying step at 40 to 100° C. and more preferably at 80 to 100° C.

Typical vinyl monomers used in the invention include:
1. unsaturated monomers belonging to the general class of methacrylates, e.g. C1-C30 alkyl irrespective of the functionality;
2. unsaturated monomers belonging to the general class of acrylates, e.g. C1-C30 alkyl irrespective of the functionality;
3. unsaturated hydrocarbon monomers like e.g. butadiene, isoprene, styrene, vinyltoluene, a-methylstyrene, tert.-butylstyrene etc.;
4. unsaturated monomers belonging to the class of vinylhalides, vinylesters, vinylethers;
5. multi-olefinically unsaturated monomers such as di-allylphthalate, allylmethacrylate; and
6. any multi unsaturated monomers of any of the aforementioned types.

Preferably at least 30 wt %, more preferably at least 50 wt %, and especially 70 wt % of the monomer composition used to form the vinyl polymer beads is derived from at least one bio-renewable olefinically unsaturated monomer. Bio-renewable monomers may be obtained fully or in part from bio-renewable sources. Thus it is preferred to also measure the carbon-14 content to determine the bio-renewability.

The content of carbon-14 (C-14) is indicative of the age of a bio-based material. It is known in the art that C-14, which has a half life of about 5,700 years, is found in bio-renewable materials but not in fossil fuels. Thus, “bio-renewable materials” refer to organic materials in which the carbon comes from non-fossil biological sources. Examples of bio-renewable materials include, but are not limited to, sugars, starches, corns, natural fibres, sugarcanes, beets, citrus fruits, woody plants, cellulosics, lignocelluosics, hemicelluloses, potatoes, plant oils, other polysaccharides such as pectin, chitin, levan, and pullulan, and a combination thereof.

C-14 levels can be determined by measuring its decay process (disintegrations per minute per gram carbon or dpm/gC) through liquid scintillation counting. In one embodiment of the present invention, polymer A and or polymer B comprise at least about 1.5 dpm/gC (disintegrations per minute per gram carbon) of carbon-14, more preferably at least 2 dpm/gC, most preferably at least 2.5 dpm/gC, and especially at least 4 dpm/gC.

Examples of bio-renewable monomers include but are not limited to bio-based acrylics obtained by for example using bio-derived alcohols such as bio-butanol and include (meth)acrylic acid and alkyl (meth)acrylate, where alkyl is preferably selected from methyl, ethyl, butyl or 2-ethylhexyl.

Acrylic acid can be made from glycerol, as is disclosed by Arkema, or from lactic acid as described by U.S. Pat. No. 7,687,661. Methacrylic acid can be prepared from ethene, methanol and carbon monoxide (all potentially bio-renewable), as disclosed by Lucite International Ltd.

Olefinically unsaturated bio-renewable monomers which may additionally provide a contribution to improved coating properties include α-methylene butyrolactone, α-methylene valerolactone, α-methylene γ-R¹ butyrolactone (R¹ can be an optionally substituted alkyl or optionally substituted aryl); itaconates such as dialkyl itaconates and monoalkyl itaconates, itaconic acid, itaconic anhydride, crotonic acid and alkyl esters thereof, citraconic acid and alkyl esters thereof, methylene malonic acid and its mono and dialkyl esters, citraconic anhydride, mesaconic acid and alkyl esters thereof.

Another useful set of useful bio-renewable monomers include N—R², α-methylene butyrolactam (R² can be an optionally substituted alkyl or optionally substituted aryl); N—R², α-methylene γ-R¹ butyrolactam; N-alkyl itaconimids; itaconmonoamids; itacondiamids; dialkyl itaconamides, mono alkyl itaconamides; furfuryl (meth)acrylate; fatty acid functional (meth)acrylates such as DAPRO FX-522 from Elementis and Visiomer MUMA from Evonik.

Improved properties may include heat resistance, colloidal stability, pigment compatibility, surface activity, blocking resistance and reduced MFFT depending on the monomers used.

The monomer system used for the preparation of the vinyl polymer beads is any suitable combination of olefinically unsaturated monomers which is amenable to copolymerisation (including the bio-renewable monomers described herein which may of course also be acid-functional, crosslinkable etc at described below.).

Acid-functional olefinically unsaturated monomers include a monomer bearing an acid-forming group which yields, or is subsequently convertible to, such an acid-functional group (such as an anhydride, e.g. methacrylic anhydride or maleic anhydride).

Typically the acid-bearing co-monomers are carboxyl-functional acrylic monomers or other ethylenically unsaturated carboxyl bearing monomers such as acrylic acid, methacrylic acid, itaconic acid, crotonic acid and fumaric acid. Sulphonic acid-bearing monomers could also e.g. be used, such as styrene p-sulphonic acid (or correspondingly styrene p-sulphonyl chloride). Phosphated acid-bearing monomers could also be used; examples including, for instance, phosphated HEA, phosphated HEMA, Sipomer PAM100 (ex. Rhodia) or Sipomer PAM 200 (ex. Rhodia). An acid bearing monomer could be polymerised as the free acid or as a salt, e.g. the NH₄ or alkali metal salts of ethylmethacrylate-2-sulphonic acid or 2-acrylamido-2-methylpropane sulphonic acid, or the corresponding free acids.

Other, non-acid functional, non-crosslinking monomers which may be copolymerised with the acid monomers include acrylate and methacrylate esters and styrenes; also dienes such as 1,3-butadiene and isoprene, vinyl esters such as vinyl acetate, and vinyl alkanoates. Methacrylates include normal or branched alkyl esters of C1 to C12 alcohols and methacrylic acid, such as methyl methacrylate, ethyl methacrylate, and n-butyl methacrylate, and (usually C5 to C12) cycloalkyl methacrylates acid such as isobornyl methacrylate and cyclohexyl methacrylate. Acrylates include normal and branched alkyl esters of C1 to C12 alcohols and acrylic acid, such as methyl acrylate, ethyl acrylate, n-butyl acrylate, and 2-ethylhexyl acrylate, and (usually C5-C12) cycloalkyl acrylates such as isobornyl acrylate and cyclohexylacrylate. Styrenes include styrene itself and the various substituted styrenes, such as .alpha.-methyl styrene and t-butyl styrene. Nitriles such as acrylonitrile and methacrylonitrile may also be polymerised, as well as olefinically unsaturated halides such as vinyl chloride, vinylidene chloride and vinyl fluoride.

Functional monomers which impart crosslinkability (crosslinking monomers for short) include epoxy (usually glycidyl) and hydroxyalkyl (usually C1-C12, e.g. hydroxyethyl)methacrylates and acrylates, as well as keto or aldehyde functional monomers such as acrolein, methacrolein and vinyl methyl ketone, the acetoacetoxy esters of hydroxyalkyl (usually C1-C12) acrylates and methacrylates such as acetoacetoxyethyl methacrylate and acrylate, and also keto-containing amides such as diacetone acrylamide. The purpose of using such functional monomer is to provide subsequent crosslinkability in the resulting polymer system as discussed. (In principle the functional monomer used for imparting crosslinkability could be acid-bearing monomer, but this is not usual) and for the purpose of this invention acid-bearing monomers are not considered as crosslinking monomers.

The vinyl polymer beads made according to the present invention preferably have a molecular weight in the range of from preferably 5,000 to 100,000 g/mol.

The vinyl polymer beads made according to the present invention preferably have a glass transition temperature in the range of from 35° C. to 150° C. and more preferably in the range of from 50° C. to 115° C.

The vinyl polymer beads made according to the present invention preferably have an average particle size of about 50 to 600 μm (micron) such as 200 to 500 μm (micron).

The vinyl polymer beads made according to the present invention in one embodiment preferably have an acid value in the range of from 0 to 20 mgKOH/g.

The vinyl polymer beads made according to the present invention in another embodiment preferably have an acid value in the range of from 45 to 70 mgKOH/g when used for printing compositions.

The vinyl polymer beads made according to the present invention in another embodiment preferably have an acid value in the range of from 100 to 150 mgKOH/g when used for personal care compositions.

It is appreciated that certain features of the invention, which are for clarity described in the context of separate embodiments may also be provided in combination in a single embodiment. Conversely various features of the invention, which are for brevity, described in the context of a single embodiment, may also be provided separately or in any suitable sub-combination.

Unless the context clearly indicates otherwise, as used herein plural forms of the terms herein are to be construed as including the singular form and vice versa.

The term “comprising” as used herein will be understood to mean that the list following is non exhaustive and may or may not include any other additional suitable items, for example one or more further feature(s), component(s), ingredient(s) and/or substituent(s) as appropriate.

The terms ‘effective’, ‘acceptable’ ‘active’ and/or ‘suitable’ (for example with reference to any process, use, method, application, preparation, product, material, formulation, compound, monomer, oligomer, polymer precursor, and/or polymers described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products.

Preferred utility of the present invention comprises as a coating composition.

In the discussion of the invention herein, unless stated to the contrary, the disclosure of alternative values for the upper and lower limit of the permitted range of a parameter coupled with an indicated that one of said values is more preferred than the other, is to be construed as an implied statement that each intermediate value of said parameter, lying between the more preferred and less preferred of said alternatives is itself preferred to said less preferred value and also to each less preferred value and said intermediate value.

For all upper and/or lower boundaries of any parameters given herein, the boundary value is included in the value for each parameter. It will also be understood that all combinations of preferred and/or intermediate minimum and maximum boundary values of the parameters described herein in various embodiments of the invention may also be used to define alternative ranges for each parameter for various other embodiments and/or preferences of the invention whether or not the combination of such values has been specifically disclosed herein.

It will be understood that the total sum of any quantities expressed herein as percentages cannot (allowing for rounding errors) exceed 100%. For example the sum of all components of which the composition of the invention (or part(s) thereof) comprises may, when expressed as a weight (or other) percentage of the composition (or the same part(s) thereof), total 100% allowing for rounding errors. However where a list of components is non exhaustive the sum of the percentage for each of such components may be less than 100% to allow a certain percentage for additional amount(s) of any additional component(s) that may not be explicitly described herein.

The term “substantially” as used herein may refer to a quantity or entity to imply a large amount or proportion thereof. Where it is relevant in the context in which it is used “substantially” can be understood to mean quantitatively (in relation to whatever quantity or entity to which it refers in the context of the description) there comprises a proportion of at least 80%, preferably at least 85%, more preferably at least 90%, most preferably at least 95%, especially at least 98%, for example about 100% of the relevant whole. By analogy the term “substantially-free” may similarly denote that quantity or entity to which it refers comprises no more than 20%, preferably no more than 15%, more preferably no more than 10%, most preferably no more than 5%, especially no more than 2%, for example about 0% of the relevant whole.

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl group). Preferred optional substituents comprise: carboxy, sulpho, hydroxy, amino, mercapto, cyano, methyl, halo, trihalomethyl and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclic groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen, silicon and/or sulphur, more preferably from hydrogen, nitrogen, oxygen, phosphorus and/or sulphur.

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group).

The term ‘hydrocarbo group’ as used herein is a sub-set of a organic group and denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylidene groups comprise divalent groups (which may be represented by “R₂C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC≡”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups); aromatic groups (e.g. in aryl groups) and/or combinations thereof within the same moiety and where indicated may be substituted with other functional groups

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N}organo, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in an organo group is from 1 to 12, especially from 1 to 10 inclusive, for example from 1 to 4 carbon atoms.

As used herein chemical terms (other than IUAPC names for specifically identified compounds) which comprise features which are given in parentheses—such as (alkyl)acrylate, (meth)acrylate and/or (co)polymer—denote that that part in parentheses is optional as the context dictates, so for example the term (meth)acrylate denotes both methacrylate and acrylate.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers (e.g. E and/or Z forms), diastereoisomers and/or geometric isomers); tautomers (e.g. keto and/or enol forms), conformers, salts, zwitterions, complexes (such as chelates, clathrates, crown compounds, cyptands/cryptades, inclusion compounds, intercalation compounds, interstitial compounds, ligand complexes, organometallic complexes, non-stoichiometric complexes, π(pi)-adducts, solvates and/or hydrates); isotopically substituted forms, polymeric configurations [such as homo or copolymers, random, graft and/or block polymers, linear and/or branched polymers (e.g. star and/or side branched), cross-linked and/or networked polymers, polymers obtainable from di and/or tri-valent repeat units, dendrimers, polymers of different tacticity (e.g. isotactic, syndiotactic or atactic polymers)]; polymorphs (such as interstitial forms, crystalline forms and/or amorphous forms), different phases, solid solutions; and/or combinations thereof and/or mixtures thereof where possible. The present invention comprises and/or uses all such forms which are effective as defined herein.

Polymers of the present invention may be prepared by one or more suitable polymer precursor(s) which may be organic and/or inorganic and comprise any suitable (co)monomer(s), (co)polymer(s) [including homopolymer(s)] and mixtures thereof which comprise moieties which are capable of forming a bond with the or each polymer precursor(s) to provide chain extension and/or cross-linking with another of the or each polymer precursor(s) via direct bond(s) as indicated herein.

Polymer precursors of the invention may comprise one or more monomer(s), oligomer(s), polymer(s); mixtures thereof and/or combinations thereof which have suitable polymerisable functionality.

A monomer is a substantially monodisperse compound of a low molecular weight (for example less than one thousand daltons) which is capable of being polymerised.

A polymer is a polydisperse mixture of macromolecules of large molecular weight (for example many thousands of daltons) prepared by a polymerisation method, where the macromolecules comprises the multiple repetition of smaller units (which may themselves be monomers, oligomers and/or polymers) and where (unless properties are critically dependent on fine details of the molecular structure) the addition or removal one or a few of the units has a negligible effect on the properties of the macromolecule.

A oligomer is a polydisperse mixture of molecules having an intermediate molecular weight between a monomer and polymer, the molecules comprising a small plurality of monomer units the removal of one or a few of which would significantly vary the properties of the molecule.

Depending on the context the term polymer may or may not encompass oligomer.

The polymer precursor of and/or used in the invention may be prepared by direct synthesis or (if the polymeric precursor is itself polymeric) by polymerisation. If a polymerisable polymer is itself used as a polymer precursor of and/or used in the invention it is preferred that such a polymer precursor has a low polydispersity, more preferably is substantially monodisperse, to minimise the side reactions, number of by-products and/or polydispersity in any polymeric material formed from this polymer precursor. The polymer precursor(s) may be substantially un-reactive at normal temperatures and pressures.

Except where indicated herein polymers and/or polymeric polymer precursors used in the invention can be (co)polymerised by any suitable means of polymerisation well known to those skilled in the art. Examples of suitable methods comprise: thermal initiation; chemical initiation by adding suitable agents; catalysis; and/or initiation using an optional initiator followed by irradiation, for example with electromagnetic radiation (photo-chemical initiation) at a suitable wavelength such as UV; and/or with other types of radiation such as electron beams, alpha particles, neutrons and/or other particles.

The substituents on the repeating unit of a polymer and/or oligomer may be selected to improve the compatibility of the materials with the polymers and/or resins in which they may be formulated and/or incorporated for the uses described herein. Thus the size and length of the substituents may be selected to optimise the physical entanglement or interlocation with the resin or they may or may not comprise other reactive entities capable of chemically reacting and/or cross linking with such other resins as appropriate.

The following examples are provided to further illustrate the processes and compositions of the present invention. These examples are illustrative only and are not intended to limit the scope of the invention in any way.

Various registered trademarks, other designations and/or abbreviations are used herein to denote some of ingredients used to prepare polymers and compositions of the invention. These are identified below by chemical name and/or trade-name and optionally their manufacturer or supplier from whom they are available commercially. However where a chemical name and/or supplier of a material described herein is not given it may easily be found for example in reference literature well known to those skilled in the art: such as: ‘McCutcheon's Emulsifiers and Detergents’, Rock Road, Glen Rock, N.J. 07452-1700, USA, 1997 and/or Hawley's Condensed Chemical Dictionary (14th Edition) by Lewis, Richard J., Sr.; John Wiley & Sons.

BMA denotes n-butyl methacrylate

DDM denotes n-dodecyl mercaptane

DLP denotes dilauryl peroxide

DEI denotes diethyl itaconate

DMI denotes dimethyl itaconate

DMW denotes dematerialized water

EA denotes ethyl acrylate

HFIP denotes hexafluoro isopropanol

KTFA denotes potassium trifluoro actetate

MMA denotes methyl methacrylate.

NS denotes sodium sulphate

PAA denotes polyacrylic acid

STY denotes stryene

### Glass Transition Temperature

As is well known, the glass transition temperature of a polymer is the temperature at which it changes from a glassy, brittle state to a plastic, rubbery state. The glass transition temperatures may be determined experimentally using differential scanning calorimetry DSC, taking the peak of the derivative curve as Tg, or calculated from the Fox equation. Thus the Tg, in degrees Kelvin, of a copolymer having “n” copolymerised co-monomers is given by the weight fractions W of each comonomer type and the Tg of the homopolymer (in degrees Kelvin) derived from each comonomer according to the equation:

$$\frac{1}{Tg} = \frac{{W}_{1}}{{Tg}_{1}} + \frac{{W}_{2}}{{Tg}_{2}} + ... \frac{{W}_{n}}{{Tg}_{n}}$$

The calculated Tg in degrees Kelvin may be readily converted to ° C.

### Determination of Molecular Weight of a Polymer:

The molecular weight of a polymer may be determined using Size Exclusion Chromatography with tetrahydrofuran as the eluent or with 1,1,1,3,3,3 hexafluoro isopropanol as the eluent.

### 1) Tetrahydrofuran

The SEC analyses were performed on an Alliance Separation Module (Waters 2690), including a pump, autoinjector, degasser, and column oven. The eluent was tetrahydrofuran (THF) with the addition of 1.0 vol % acetic acid. The injection volume was 150 μl. The flow was established at 1.0 ml/min. Three PL MixedB (Polymer Laboratories) with a guard column (3 μm PL) were applied at a temperature of 40° C. The detection was performed with a differential refractive index detector (Waters 410). The sample solutions were prepared with a concentration of 20 mg solids in 8 ml THF (+1 vol % acetic acid), and the samples were dissolved for a period of 24 hours. Calibration is performed with eight polystyrene standards (polymer standard services), ranging from 500 to 4,000,000 g/mol. The calculation was performed with Millenium 32 software (Waters) with a third order calibration curve. The obtained molar masses are polystyrene equivalent molar masses (g/mol).

### 2) 1,1,1,3,3,3 Hexafluoro Isopropanol

The SEC analyses were performed on a Waters Alliance 2695 (pump, degasser and autosampler) with a Shodex RI-101 differential refractive index detector and Shimadzu CTO-20AC column oven. The eluent was 1,1,1,3,3,3 hexafluoro isopropanol (HFIP) with the addition of 0.2M potassium trifluoro actetate (KTFA). The injection volume was 50 μl. The flow was established at 0.8 ml/min. Two PSS PFG Linear XL columns (Polymer Standards Service) with a guard column (PFG PSS) were applied at a temperature of 40° C. The detection was performed with a differential refractive index detector. The sample solutions were prepared with a concentration of 5 mg solids in 2 ml HFIP (+0.2M KTFA), and the samples were dissolved for a period of 24 hours. Calibration is performed with eleven polymethyl methacrylate standards (polymer standard services), ranging from 500 to 2,000,000 g/mol. The calculation was performed with Empower Pro software (Waters) with a third order calibration curve. The molar mass distribution is obtained via conventional calibration and the molar masses are polymethyl methacrylate equivalent molar masses (g/mol).

### EXAMPLE 1

In a three necked spherical flask equipped with Pt100, stirrer, cooler and nitrogen inlet 950 g of demineralised water, 1.6 g of sodium sulphate and 7.9 g of a 20 wt % polyacrylic acid solution (weight average molecular weight (M_{W})=100,000 g/mole) was added. Under constant stirring and nitrogen purge a dispersed phase consisting of 474 g methyl methacrylate (MMA), 158 g dimethyl itaconate (DMI) (bio-renewable), 9.48 g dilauroylperoxide and 1.58 g dodecylmercaptane (DDM) was added. Reactor contents were heated to 75° C. and left to polymerize for a period of 4 hours. Temperature was accordingly taken up to 90° C. and left for another hour. Resulting hard polymer beads were cooled down to room temperature, reactor unloaded and polymer beads washed thoroughly and separated from the continuous phase by centrifuging and left to dry at 40° C. Polymer obtained had an average particle size of 212 microns, a DSC derived Tg of 100° C. and a GPC derived weight average molecular weight of 100000 g/mol.

### EXAMPLE 2

To a round-bottomed flask equipped with a condenser, thermometer, nitrogen inlet and mechanical stirrer are charged 950 parts of water, 1.6 parts of sodium sulphate, and 7.9 parts of a 20 wt-% solution of polyacrylic acid (PAA) (weight average molecular weight (M_{W}))=100,000 g/mole). Under constant stirring and nitrogen purge a dispersed phase consisting of 253 parts of dimethyl itaconate (DMI), 126 parts of ethyl acrylate (EA), 253 parts of methyl methacrylate (MMA), 9.48 parts of dilauryl peroxide (DLP), and 1.58 parts of dodecyl mercaptane (DDM) are added. The reactor contents are heated to 75° C. and allowed to polymerize for a period of 5 hours. Next, the temperature was increased to 90° C. and the reactor contents are allowed to stir for another hour. Next, the resulting polymerization mixture is cooled down to room temperature.

The polymer beads are separated from the continuous phase and washed with water and left to dry at 40° C. The polymer thus obtained has a mean particle size of 230 mm and a Tg, as determined with DSC, of 67° C.

### EXAMPLES 3 TO 6

Further examples may be prepared according the common method below and reference to Table 1.

### Common Method

To the equipment described in Example 1 the following ingredients can be added.

‘a’ g of demineralised water (DMW),

‘b’ g of sodium sulphate (NS) and

‘c’ g of polyacrylic acid (PAA) solution (x % by weight).

Under constant stirring and nitrogen purge a dispersed phase can be added consisting of

‘d’ g of monomer A,

‘e’ g of monomer B

‘f’ g of Initiator C and

‘h’ g of Chain transfer agent (CTA) D.

The rest of the process can be followed in Table 1 as described in Example 1 to obtain a polymer analogous to that described in Example 1.

TABLE 1

| Example | MMA | BMA | DEI | DDM | [Co] | PS (m) | Tg (C) |
|---|---|---|---|---|---|---|---|
| 3 | 326 | 316 | | 1.58 | | 218 | 58 |
| 4 | | 474 | 158 | 1.58 | | 268 | 34 |
| 5 | 632 | | | | 0.025 | 310 | 98 |
| 6 | 411 | | 221 | 1.45 | | 205 | 86 |

[Co]: Cobalt chelate concentration
PS: particle size

1. A process for preparing vinyl polymer beads having a molecular weight in the range of from 3,000 to 500,000 g/mol and a glass transition temperature in the range of from 30° C. to 175° C. and an acid value in the range of from 0 to 150 mg KOH/g; said process comprising aqueous suspension polymerisation of olefinically unsaturated monomers using a free-radical initiator, wherein at least 20 wt % of the olefinically unsaturated monomers used is derived from at least one bio-renewable olefinically unsaturated monomer.

2. A process for preparing vinyl polymer beads according to claim 1 wherein the bio-renewable monomers are selected from the group consisting bio-renewable (meth)acrylic acid and or bio-renewable alkyl (meth)acrylate.

3. A process for preparing vinyl polymer beads according to claim 1 wherein the bio-renewable monomers are selected from the group consisting of bio-renewable: α-methylene butyrolactone, α-methylene valerolactone, α-methylene γ-R¹ butyrolactone (R¹ can be an optionally substituted alkyl or optionally substituted aryl); itaconates such as dialkyl itaconates and monoalkyl itaconates, itaconic acid, itaconic anhydride, crotonic acid and alkyl esters thereof, citraconic acid and alkyl esters thereof, methylene malonic acid and its mono and dialkyl esters, citraconic anhydride, mesaconic acid and alkyl esters thereof.

4. A process for preparing vinyl polymer beads according to claim 1 wherein the bio-renewable monomers are selected from the group consisting of bio-renewable: N—R², α-methylene butyrolactam (R² can be an optionally substituted alkyl or optionally substituted aryl); N—R², α-methylene γ-R¹ butyrolactam; N-alkyl itaconimids; itaconmonoamids; itacondiamidsialkyl itaconamides, mono alkyl itaconamides; furfuryl (meth)acrylate; and fatty acid functional (meth)acrylates.

5. A process for preparing vinyl polymer beads according to claim 1 wherein vinyl polymer beads and comprise at least about 1.5 dpm/gC of carbon-14.

6. A process for preparing vinyl polymer beads according to claim 1 wherein the acid value of the vinyl beads is in the range of from 0 to 20 mgKOH/g.

7. A process for preparing vinyl polymer beads according to claim 1 wherein the acid value of the vinyl beads is in the range of from 45 to 70 mg KOH/g.

8. A process for preparing vinyl polymer beads according to claim 1 for use in personal care compositions wherein the acid value of the vinyl beads is in the range of from 100 to 150 mg KOH/g.

9. A process for preparing vinyl polymer beads according to claim 1 wherein said process further comprises the isolation of the beads followed by a drying step at 40 to 100° C.

10. A process for preparing vinyl polymer beads claim 9 wherein the drying step is carried out over a period of 3 to 40 h.

11. Vinyl polymer beads obtainable by a process according to claim 1

12. A composition comprising the vinyl polymer beads according to claim 11 and a carrier.

13. A method of coating a surface of a substrate with a composition comprising vinyl beads prepared using a process according to claim 1 comprising the steps of applying the composition to the surface and then drying the composition.

14. A method according to claim 13 wherein the substrate is selected from the group consisting of tarmac, wood, plastic, metal and paper.

15. Use of a composition comprising the vinyl polymer beads according to claim 11 and a bio-renewable liquid medium as a coating composition.
